(19) United States
(12) Patent Application Publication
(10) Pub. No.: US 2008/0250173 A1
(43) Pub. Date: Oct. 9, 2008

(54) Communication adapter and data transfer method of communication adapter

(75) Inventor: Kenichi Ueda, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/078,728

(22) Filed: Apr. 3, 2008

(30) Foreign Application Priority Data
Apr. 4, 2007 (JP) 2007-098016

(51) Int. Cl. G06F 13/12

(52) U.S. Cl. 710/63

(57) ABSTRACT

A communication adapter comprises a host controller to interact with a connected device that is USB connected to the communication adapter, a wireless communication unit which communicates with an external wireless communication apparatus, and which has an endpoint configuration that corresponds one-to-one to an endpoint configuration of the connected device, and a data convertor which converts data from the wireless communication apparatus into data to be transmitted to the connected device, and converts data from the connected device into data to be transmitted to the wireless communication apparatus. Data transfer is performed between the wireless communication apparatus and the connected device.

### BACKGROUND OF THE INVENTION

1. Field of the Invention

The present invention relates to a communication adapter that connects a Certified Wireless USB host to an Up Port and a Wired USB device to a Down Port to enable data transfer between the two, and a data transfer method of the communication adapter.

2. Description of Related Art

A communication apparatus setting method has been disclosed in the related art (see Japanese Unexamined Patent Application Publication No. 2006-148311, for example) with the object of simplifying wireless communication-related setting in a communication apparatus that can use a specific type of device such as a printer apparatus or a digital composite machine from an external wireless communication apparatus when connected to the specific type of device.

In this communication apparatus setting method, the wireless apparatus comprises a USB interface for electrically connecting a digital composite machine, which serves as the specific type of device, to a storage apparatus, and when a connection is detected between the USB interface and the storage apparatus, a determination is made as to whether or not setting information indicating the content of wireless communication-related setting is stored in the storage device connected to the USB interface. When a setting information file is determined to be stored in the storage apparatus, the storage apparatus reads the stored setting information file and modifies the values of various wireless operation parameters in accordance with the content of the setting file. Thus, setting relating to wireless communication is performed.

Incidentally, a Certified Wireless USB (to be referred to hereafter as a C-WUSB) exists as a wireless communication system aimed at achieving USB compatibility. A feature of a C-WUSB is its ability to realize an equivalent performance to pre-existing USB 2.0, i.e. “the maximum theoretical data transfer speed of 480 Mbps at a distance of approximately 3 m for connecting a personal computer to a peripheral machine”. With C-WUSB technology, the installation of machines requiring high-speed, large-volume data transfer, such as printers and external storage, is facilitated, and the need to carry cables for transferring the data of a portable machine such as a portable HDD player or a digital camera is eliminated.

Further, C-WUSB standards have much in common with conventional USB standards, and for the purpose of migration from a pre-existing system, the pre-existing system can be made compatible with a C-WUSB by attaching a module that conforms to C-WUSB standards internally or externally. Therefore, in a personal computer or the like, a pre-existing driver can be used as is.

Further, when a WiMedia-conforming UWB system is employed, a reduction in the power consumption of a transmission/reception circuit can be realized in addition to high-speed wireless communication. Further, when a plurality of personal computers and peripheral machines exist, C-WUSB communication is performed by determining a master/slave relationship of “host (a personal computer, a game machine, or the like)” and “device (a peripheral machine)” among the machines in advance such that the connection configuration of the communicating network is limited to one-to-many, in contrast to a wireless system based on many-to-many communication, and as a result, a reduction in circuit scale is realized. Moreover, since CMOS technology can be used in an RF processing unit, a pre-existing production line can be appropriated, and therefore production costs can be reduced and future integration can be responded to with ease.

Moreover, a host and a device that are compatible with a C-WUSB are capable of communicating with each other without special setting. On the other hand, when security setting is not performed, anyone within the radio wave range can receive data, and therefore data may be stolen or rewritten without the knowledge of the user. Hence, measures to prevent this must be taken in advance. With a C-WUSB, a setup operation that passes through a special procedure is used between the host and the device to ensure wired-quality security. This procedure will be referred to hereafter as association.

In a C-WUSB, two new device classes known as wire adapters are defined so that pre-existing USB hosts (personal computers) and USB devices can be connected for wireless communication. By using a wire adapter device, a pre-existing personal computer can be upgraded to become capable of supporting a C-WUSB. One of these device classes is an HWA (host wire adapter), which is a device having a wired USB 2.0 [device] on its upstream side. An HWA operates as the host of a downstream C-WUSB device.

The other device class is a DWA (device wire adapter), which is a USB device that uses a C-WUSB for upstream connections. A DWA operates as a USB 2.0 (wired) host in relation to a device connected to a downstream port thereof.

FIG. 15 is a block diagram showing a DWA. A C-WUSB DWA unit comprises a UWB PHY 111 serving as a physical layer, a MAC unit 112, and an endpoint (EP) controller 113 serving as a C-WUSB data transmission/reception buffer, which together constitute a C-WUSB Up Port unit 110, a Remote Pipe controller 120 for controlling a Remote Pipe (RPipe), i.e. a mechanism for storing information such as the address of the connected device, EP information, the transfer system, and so on, and a USB 2.0 Host controller 131 and a USB 2.0 PHY 132 serving as a physical layer, which together constitute a USB 2.0 Down Port unit 130 (see Wireless USB Specification Revision 1.0, Chapter 8, p 195-p 202, [online], [search performed on Jan. 23, 2007], Internet <URL: http://www.usb.org/developers/wusb/>).

Since a DWA can be connected to any device, it is superior in terms of universality, and when positioned such that the Up port is C-WUSB and the Down Port is a Wireless HUB of the Wired USB, a DWA can turn a pre-existing USB machine into a C-WUSB easily.

However, a DWA includes the concept of a Remote Pipe (a mechanism for storing information such as the address of the connected device, the EP number, the transfer system, and so on) in addition to an endpoint, and a controller (Remote Pipe controller) is required to control the Remote Pipe. Further, since a DWA is basically incapable of limiting the devices that are connected to the USB 2.0 Down Port, the USB 2.0 Host unit cannot be simplified, and when the Down Port is multi-port-compatible, the analog unit (physical layer) increases correspondingly in size, leading to an increase in the circuit scale.

Furthermore, due to the universality of a DWA, protocol overheads are large, and therefore throughput (execution speed) is low. In other words, a DWA invariably requires Transfer Request reception and Transfer Result transmission as transfer units, and therefore two extra C-WUSB transactions are required in comparison with a Native Device (ND), leading to a reduction in the data transfer speed. An ND, meanwhile, is superior to a DWA in terms of throughput and circuit scale, but since C-WUSB control is highly dependent on the system bus, an ND cannot turn a Wired USB into a C-WUSB easily.

### SUMMARY

In one embodiment, there is provided a communication adapter comprises a host controller to interact with a connected device that is USB connected to the communication adapter, a wireless communication unit which communicates with an external wireless communication apparatus, and which has an endpoint configuration that corresponds one-to-one to an endpoint configuration of the connected device, and a data convertor which converts data from the wireless communication apparatus into data to be transmitted to the connected device, and converts data from the connected device into data to be transmitted to the wireless communication apparatus, wherein data transfer is performed between the wireless communication apparatus and the connected device.

In the present invention, a wireless communication unit having an endpoint configuration that corresponds one-to-one to an endpoint configuration of a connected device is provided, and therefore data transfer can be performed with an external wireless communication apparatus regarding the connected device as a wireless USB, for example. Hence, protocol overheads are small, and the transfer speed can be increased.

In the other embodiment, there is provided a data transfer method of a communication adapter for performing data transfer between a connected device that is USB connected to the communication adapter and an external wireless communication apparatus, the method comprising the steps of receiving a transmission request from the external wireless communication apparatus in a wireless communication unit having an endpoint configuration that corresponds one-to-one to an endpoint configuration of the connected device, issuing an IN token to the connected device and receiving data from the connected device, and transferring the data to the wireless communication apparatus from the connected device.

In the present invention, data can be received from the connected device upon reception of a transmission request (to be referred to hereafter as an IN token, together with the USB) from the wireless communication apparatus, without the need to transfer and receive a transfer request and a transfer result, and therefore data transfer can be increased in speed.

In the other embodiment, there is provided a data transfer method of a communication adapter for performing data transfer between a USB device connected to the communication adapter and an external wireless communication apparatus, the method comprising the steps of issuing an IN token to a connected device and obtaining data regardless of whether or not an IN token is received from the external wireless communication apparatus by a wireless communication unit having an endpoint configuration that corresponds one-to-one to an endpoint configuration of the connected device, and transferring the data obtained from the connected device after the wireless communication unit has received an IN token from the wireless apparatus.

In the present invention, data can be obtained from the connected device regardless of whether or not the IN token has been received from the wireless communication apparatus, and therefore a further increase in the speed of data transfer can be achieved.

According to the present invention, a communication adapter that can turn a pre-existing USB machine into a C-WUSB easily while realizing a high level of performance, and a data transfer method thereof, can be provided.

### BRIEF DESCRIPTION OF THE DRAWINGS

The above and other objects, advantages and features of the present invention will be more apparent from the following description of certain preferred embodiments taken in conjunction with the accompanying drawings, in which:

FIGS. 1A and 1B are views showing a communication system according to a first embodiment of the present invention;

FIG. 2 is a block diagram showing the communication adapter according to the first embodiment of the present invention;

FIG. 3 is a view showing the endpoint controller in detail according to the first embodiment of the present invention;

FIGS. 4A and 4B are flowcharts illustrating WUSB standard request processing in the first embodiment of the present invention and a DWA, respectively;

FIG. 5 is a block diagram showing the WUSB-USB convertor 20 in detail;

FIGS. 6A and 6B are flowcharts showing an operation of the communication adapter according to the first embodiment of the present invention and a DWA, respectively;

FIGS. 7A and 7B are flowcharts showing IN data transfer processing during a device operation of the communication adapter according to the first embodiment of the present invention and a DWA, respectively;

FIG. 8A is a flowchart showing an OUT data transfer method of the communication adapter according to this embodiment and FIG. 8B is a flowchart showing an OUT transfer method of a DWA for comparison;

FIG. 9 is a flowchart showing in detail IN data transfer processing in the communication adapter according to the first embodiment of the present invention;

FIG. 10 is a flowchart showing in detail IN data transfer processing in the communication adapter according to the first embodiment of the present invention, illustrating IN data transfer processing in the mass storage class.

FIG. 11 is a flowchart showing in detail OUT data transfer processing in the communication adapter according to the first embodiment of the present invention;

FIG. 12 is a flowchart showing in detail OUT data transfer processing in the communication adapter according to the first embodiment of the present invention;

FIG. 13 is a view illustrating the effects of the first embodiment;

FIG. 14 is a block diagram showing a communication adapter according to a second embodiment of the present invention; and

FIG. 15 is a block diagram showing a DWA.

### DETAILED DESCRIPTION OF THE PREFERRED EMBODIMENTS

The invention will now be described herein with reference to illustrative embodiments. Those skilled in the art will recognize that many alternative embodiments can be accomplished using the teachings of the present invention and that the invention is not limited to the embodiments illustrated for explanatory purposes.

Specific embodiments of the present invention will be described in detail below with reference to the drawings. In these embodiments, the present invention is applied to a communication adapter capable of realizing high speed with low protocol overheads, in contrast to a DWA, by combining a C-WUSB ND and a simple Wired USB host unit.

### First Embodiment

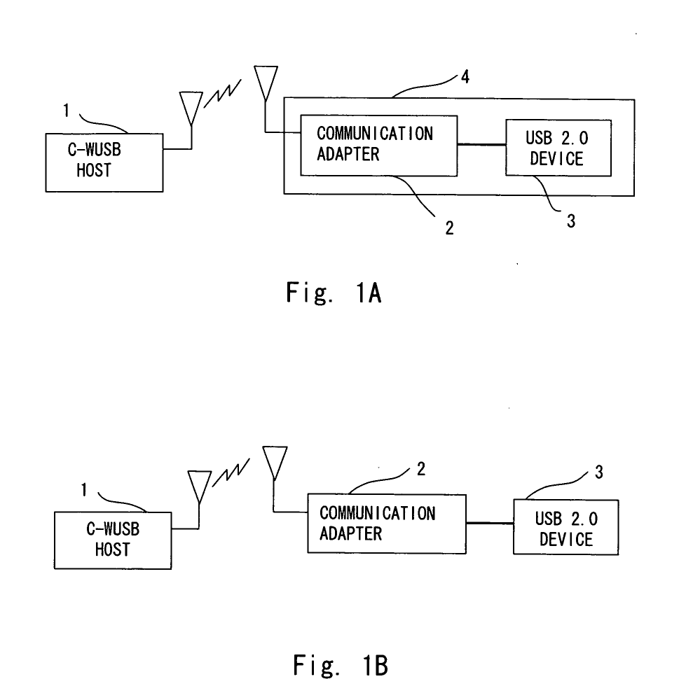

FIGS. 1A and 1B are views showing a communication system according to this embodiment. In a communication adapter 2 according to this embodiment, a C-WUSB host 1 is connected to an Up Port, and a Wired USB (USB 2.0 device) 3 is connected to a Down Port. As shown in FIG. 1A, by incorporating the communication adapter 2 and the USB 2.0 device 3 into a peripheral machine 4, [the peripheral machine 4] can be used in an incorporation application to a USB device requiring high speed. As shown in FIG. 1B, the communication adapter 2 may also be attached externally to the USB 2.0 device 3.

The communication adapter according to this embodiment turns a pre-existing Wired USB device into a Native Device (ND) that functions as a C-WUSB device. In the following description, comparisons will be made with a DWA where appropriate. Note that a DWA is also an adapter for connecting a Wired USB to a C-WUSB, but differs from the communication adapter of this embodiment in that it functions as a hub that can connect a large number of connected devices, but suffers from a large circuit scale and low speed. Note that the following description will focus on the support of a USB device having a Bulk transfer endpoint requiring high throughput. Further, Bulk transfer will be used as an example when describing an operation.

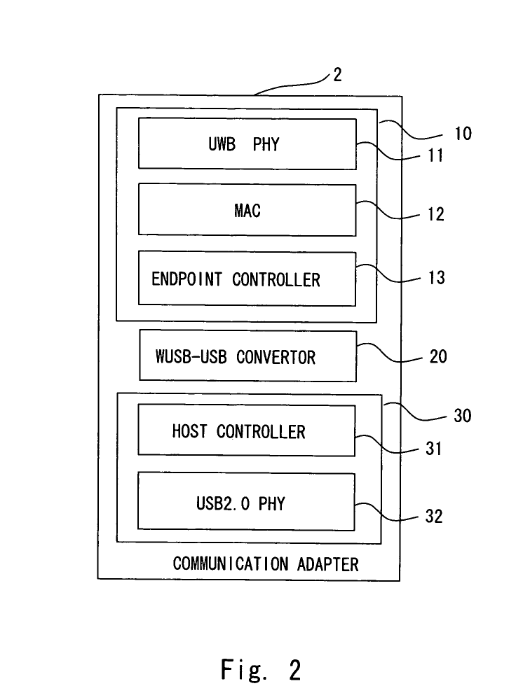

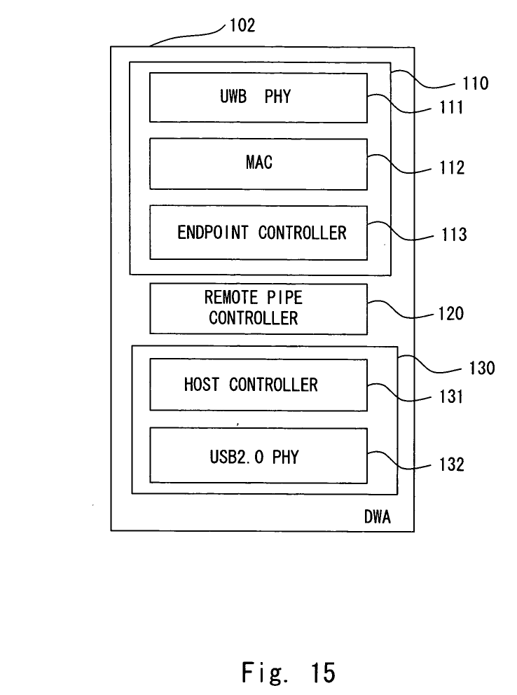

FIG. 2 is a block diagram showing the communication adapter according to this embodiment. The communication adapter 2 comprises an Up Port unit (C-WUSB ND unit) 10 serving as a C-WUSB device, a WUSB-USB convertor 20 serving as a data convertor, and a Down Port unit (a simple USB 2.0 host unit) 30. The Up Port unit 10 includes a UWB PHY 11 serving as a physical layer, a MAC unit 12, and an endpoint (EP) controller 13 serving as a C-WUSB data transmission/reception buffer, while the Down Port unit 30 includes a USB 2.0 Host controller 31 and a USB 2.0 PHY 32 serving as a physical layer. The Up Port unit 10 is a part that communicates with an external C-WUSB device, and the configuration of the endpoint controller differs partially from that of the Up Port unit 110 shown in FIG. 15. All other configurations are identical. Further, as will be described in detail below, the endpoint controller 13 of the communication adapter 2 has an endpoint configuration that corresponds one-to-one to the endpoint configuration of the connected device 3. In comparison with a conventional DWA, the endpoint configuration of the endpoint controller 13 is more dependent on the target device. Further, transfer request control and transfer result control are not required, and therefore corresponding control units can be eliminated.

The host controller 31 interacts with the connected device 3 that is USB connected to the communication adapter 2. In the Down Port unit 30, surplus port control units can be eliminated, the number of endpoints can be limited, hub connection control is not required, and so on, and therefore the Down Port unit 30 can be simplified in comparison with a DWA by eliminating a part of the host controller of the DWA. Further, in the USB 2.0 PHY 32, surplus transceivers can be eliminated, only a single port is required, and so on, and therefore the USB 2.0 PHY 32 can be simplified in comparison with a DWA by eliminating a part of the constitution thereof.

The WUSB-USB convertor 20 is a data convertor for converting wireless USB data from the C-WUSB host 1 into data for the connected device 3, and converting USB data from the USB 2.0 connected device into wireless USB data for the C-WUSB host 1. Using the communication adapter 2, data transfer is performed between the C-WUSB host 1 and the USB 2.0 device (connected device) 3.

The communication adapter according to this embodiment turns a pre-existing USB device into a C-WUSB while realizing a high level of performance. The circuit scale can be reduced in comparison with a DWA, and therefore reductions in power consumption and cost can be achieved. Further, although the connectable devices are limited, throughput can be improved by means of processing that is suited to the device class of the connection subject. Moreover, as will be described below, by providing a USB 2.0 device unit and combining it with a simple USB 2.0 host unit, the communication adapter can perform an operation as a wired USB (pre-existing USB device) as is while maintaining compatibility with cable association, which is a C-WUSB communication security system.

Here, the Up Port unit 10 and the WUSB-USB convertor 20 function as a wireless USB, while the Down Port 30 functions as a conversion adapter of a wired USB. The communication adapter 2 has an identical appearance to a 1 port DWA, but from the C-WUSB host, the communication adapter 2 and connected device 3 are recognized as a single C-WUSB device. In the case of a DWA, a USB connected device is recognized as being connected via a hub (DWA).

Furthermore, in the communication adapter 2, security-related operations and operations unique to a C-WUSB such as the processing of requests added by the C-WUSB are closed by the Up Port unit 10, whereas operations that are shared by the Up Port unit 10 and Down Port unit 30 are performed by having the WUSB-USB convertor 20 perform the required conversion processing between the Up Port unit 10 and Down Port unit 30. Note that the connected device 3 and the Up Port unit 10 have an identical endpoint configuration, and therefore the address allocated to the Up Port unit 10 is used as is as the device address of the connected device.

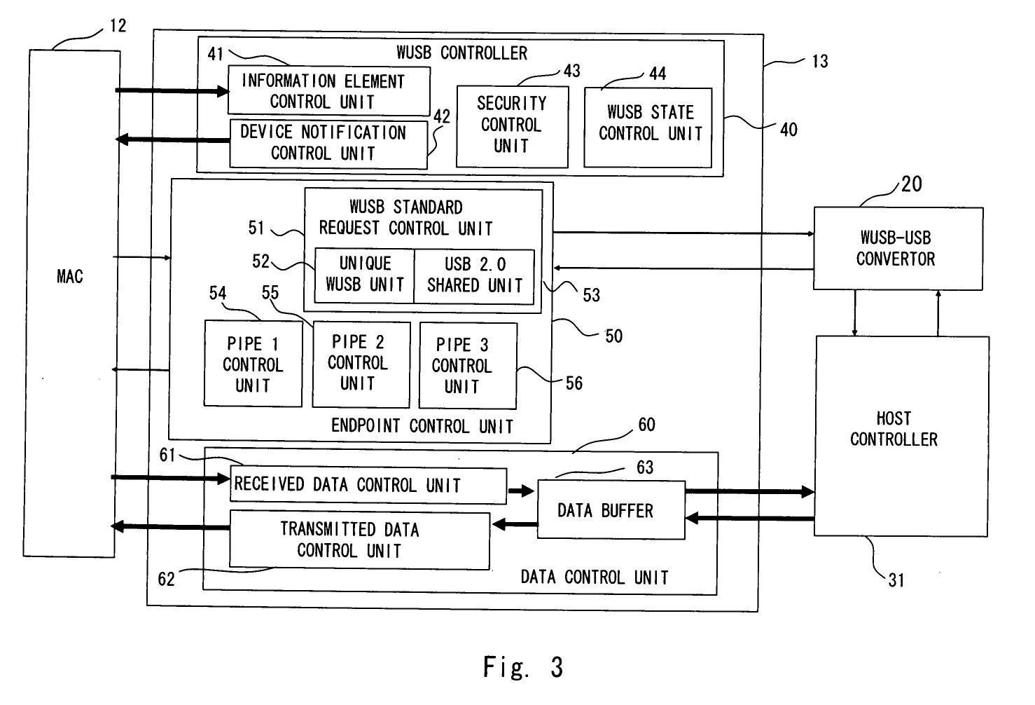

FIG. 3 is a view showing the endpoint controller in detail. Note that this example is only one example of an endpoint controller, and a block included in a certain block in the drawing may be included in another block. For example, the WUSB-USB convertor is described as being provided on the exterior of the endpoint controller 13, but may be provided in the endpoint controller 13.

The endpoint controller 13 comprises a WUSB controller 40 for controlling the WUSB protocol, an endpoint control unit 50 for controlling a WUSB device endpoint, and a data control unit 60 for controlling WUSB data.

The WUSB controller 40 comprises an information element control unit 41 for controlling Information Elements (IE) transmitted from a WUSB host, a device notification control unit 42 for controlling a Device Notification transmitted to the WUSB host, a security control unit 43 for managing and controlling wireless security-related information such as a connected host ID, a connected device ID, and a connection key, and a WUSB state control unit 44 for controlling a WUSB device state.

The data control unit 60 comprises a received data control unit 61 for controlling data received by the MAC 12 such as the deletion of a header unit, a transmitted data control unit 62 for controlling data transmitted to the MAC 12 such as the addition of a header unit, and a data buffer 63 for storing data.

The endpoint control unit 50 comprises a WUSB standard request control unit 51 for processing a WUSB standard request, a unique WUSB unit 52 for processing a unique WUSB request, i.e. a request that is not a USB 2.0 request, a USB 2.0 shared unit 53 for processing a request that is shared with USB 2.0, and a PIPE 1 control unit 54, a PIPE 2 control unit 55, and a PIPE 3 control unit 56 having variable EP numbers, transfer types, directions and so on, which are set to correspond one-to-one to the connected device. As will be described in detail below, these variable endpoints obtain configuration information relating to the connected device during enumeration with the connected device, and the EP configuration, or in other words the transfer type, the IN, OUT transfer direction, the EP number and so on are set from EP information thereof.

Note that in this embodiment, three variable endpoints are provided, but the number of endpoints is dependent on the EP configuration of the connected device, and may be four or more, for example. Further, the USB 2.0 shared unit differs from a DWA in that WUSB-USB conversion processing is required.

Further, the communication adapter 2 according to this embodiment comprises the WUSB-USB convertor 20 for performing WUSB-USB conversion processing. Note that in this embodiment, the WUSB-USB convertor 20 is described as a hardware constitution, but may be a software constitution having a built-in CPU.

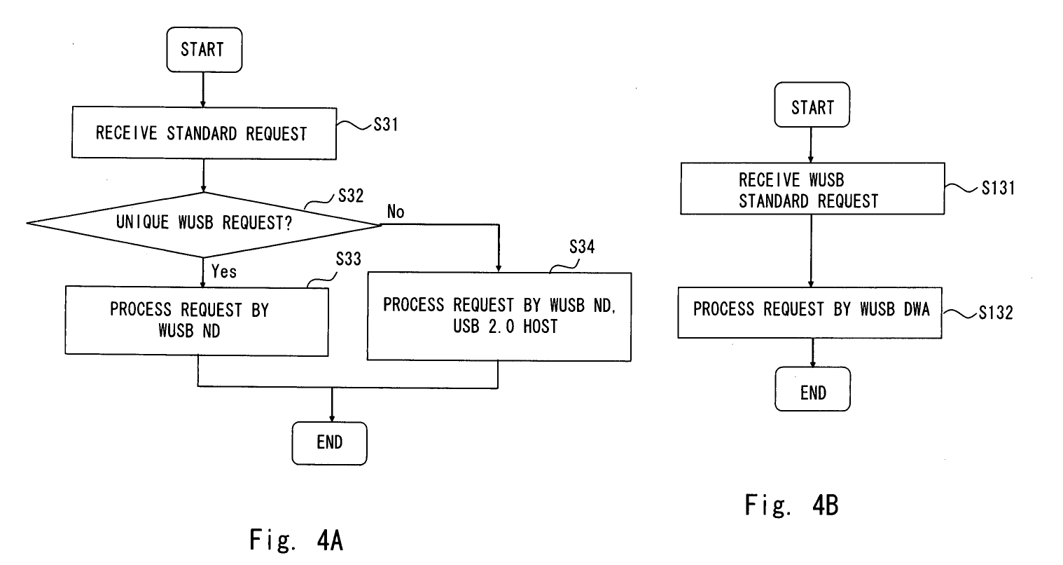

FIGS. 4A and 4B are flowcharts illustrating WUSB standard request processing in the first embodiment of the present invention and a DWA, respectively. As shown in FIG. 4B, when a C-WUSB standard request is received (step S131) in a DWA during C-WUSB standard request processing, such as obtaining C-WUSB host information, address setting, and operation setting, the request is processed by the DWA (step S132). In other words, in the case of a DWA, processing is closed in the DWA interior.

In the communication adapter according to this embodiment, on the other hand, when a WUSB standard request is received (step S31), the WUSB standard request control unit 51 determines whether or not the WUSB standard request is a unique WUSB request (step S32), and if so, the request is processed in the unique WUSB unit 52 (step S33). If, on the other hand, the WUSB standard request is not a unique WUSB request, request processing is performed not only in the Up Port unit 10, but also in the Down Port unit 30. USB 2.0 common requests include requests expanded from USB 2.0. Requests that require the partial addition of data to information from the device or partial value modification also exist, and [in these cases], request data conversion processing is implemented by the WUSB-USB convertor 20 (step S34).

In other words, from the C-WUSB host, the connected device connected to the Down Port of the communication adapter has to appear to be a C-WUSB device. For this purpose, requests closed by the Up Port unit 10, i.e. C-WUSB device-specific requests relating to security and the like, for example, and requests to be processed including the connected device connected to the Down Port must be differentiated appropriately for processing. Note that here, interaction with the Down Port is performed in a fixed sequence and can therefore be automated and provided in a hardware constitution. Needless to say, this interaction may also be realized through firmware.

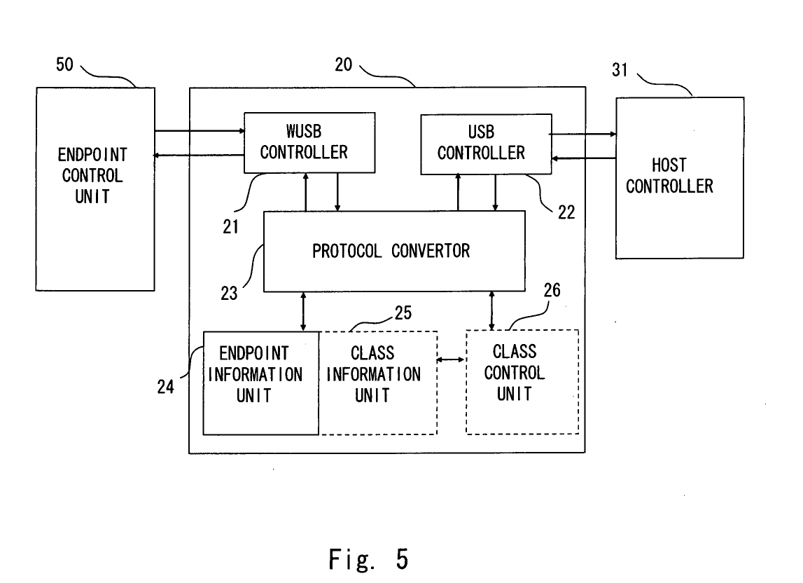

FIG. 5 is a block diagram showing the WUSB-USB convertor 20 in detail. The WUSB-USB convertor 20 comprises a USB controller 21, a WUSB controller 22, a protocol convertor 23, an EP information unit 24, a class information unit 25, and a class control unit 26. The WUSB controller 21 controls the ND (EPC) of the Up Port unit. The USB controller 22 controls the USB host controller 31 of the Down Port. The protocol convertor 23 absorbs WUSB-USB standard differences, and also implements WUSB/USB data transfer control. The EP information unit 24 extracts EP information (the transfer type, transfer direction, Max Packet Size, and so on) from the configuration information of the connected device. The EP information is based on the PIPE attribute settings of the ND (EPC). In this embodiment, to achieve a further improvement in throughput, the WUSB-USB convertor 20 also comprises the class information unit 25 and the class control unit 26. These blocks may be added as options. The class information unit 25 extracts class information from the configuration information of the connected device. Optimization processing may be implemented through class control. The class control unit 26 performs class-specific control. In the case of a Bulk Only protocol of the USB mass storage class (to be referred to hereafter as the mass storage class), for example, a CBW is decoded and optimal processing is implemented from the direction and size.

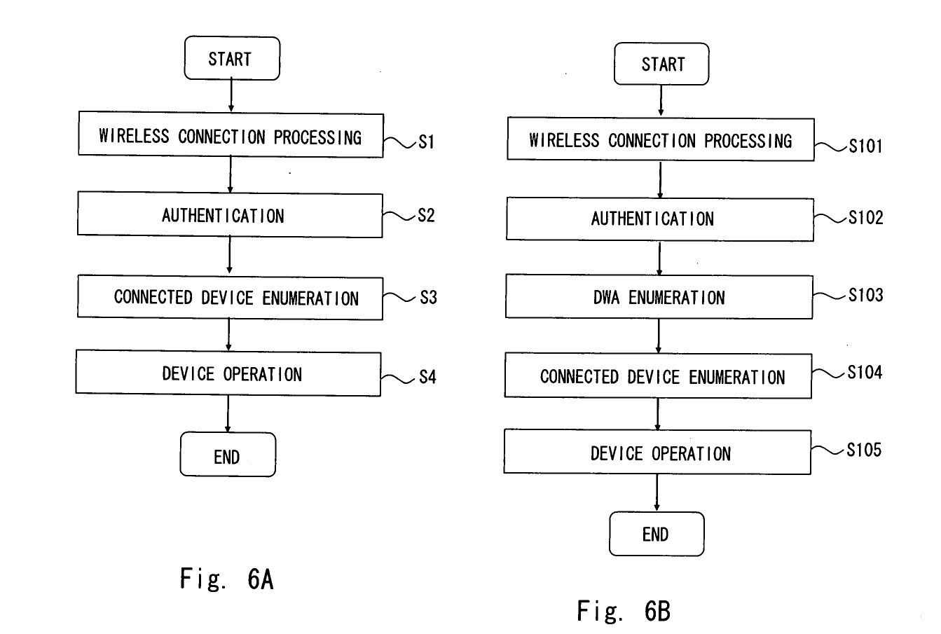

Next, referring to FIGS. 6A and 6B, an operation of the communication adapter according to this embodiment will be described. FIGS. 6A and 6B are flowcharts showing an operation of the communication adapter according to the first embodiment of the present invention and a DWA, respectively. To facilitate understanding of an operation of the communication adapter according to this embodiment, the operation will be described in comparison with an operation of a DWA. It is assumed that association processing is completed before the following operation. Note that with a DWA, even when a connected device is connected to the DWA from the start, a connected device may be connected following the completion of DWA enumeration.

As shown in FIG. 6B, once association is complete, wireless connection processing is performed by executing connection request (DN) control and connection permission (IE) control (step S101). More specifically, the DWA transmits a connection request to the C-WUSB host, and receives connection permission in response thereto. Next, security-related request processing is implemented for authentication (step S102).

Next, DWA enumeration is performed between the DWA and the C-WUSB host (step S103). Then, when a connected device is connected, connected device enumeration is performed (step S104). When a connected device is not connected, enumeration is performed following connection. Connected device enumeration is performed by exchanging information between the DWA and the connected device and between the connected device and the C-WUSB. When enumeration is complete, a device operation is executed (step S105). This device operation will be described in detail below.

Meanwhile, the communication adapter 2 according to this embodiment performs a different enumeration operation to the DWA, as shown in FIG. 6A. First, a USB device is connected to the Down Port unit. The communication adapter according to this embodiment differs from a DWA in that when a connected device is not connected, the operation of a step S1 does not begin. At this time, a USB reset is issued to the USB device by the Down Port unit 30. Next, wireless connection processing is implemented with the WUSB host (step S1). This wireless connection processing is similar to that of the DWA, and is performed by the Up Port unit 10 alone.

Next, authentication (step S2) and connected device enumeration (step S3) are performed, but here, these operations are performed using a WUSB standard request. The WUSB standard request is decoded by the WUSB standard request control unit shown in FIGS. 4A and 4B, and then processed appropriately in conjunction with the WUSB state control unit 44. Here, only principal request processing that is common to USB 2.0 will be described.

In Get Descriptor request processing, the WUSB standard request control unit 51 must transmit the device configuration information, but first, the Up Port unit 10 receives a Get Descriptor and the Down Port unit 30 issues a Get Descriptor. Next, the Up Port unit 10 issues a NAK response to an IN data request from the WUSB host, and the Down Port unit 30 issues an IN token. The Down Port unit 30 receives IN data (configuration information) from the USB device and holds the configuration information. The Up Port unit 10 transmits configuration information in response to the IN data request from the WUSB host.

Next, Set Address request processing (during Address state transition) will be described. In response to this request, device address setting is implemented by the Up Port unit 10 and Down Port unit 30. In this processing, first the Up Port unit 10 receives a Set Address and the Down Port unit 30 issues a Set Address and holds the address value. The Up Port unit 10 then issues a NAK response to an IN-ACK request from the WUSB host. The Down Port unit 30 issues an IN token. The Down Port unit 30 receives zero length data from the USB device through IN (indicating that device address setting is complete), transmits an IN-ACK to the WUSB host, and modifies the addresses managed by the Up Port unit 10 and Down Port unit 30 to the held address value described above.

Next, Set Configuration request processing (during Configured state transition) will be described. By means of this request, the device configuration is set. In this processing, first the Up Port unit 10 receives a Set Configuration and the Down Port unit 30 issues a Set Configuration. Next, the ND issues a NAK response to an IN-ACK request from the WUSB host, and the Down Port unit 30 issues an IN token. Next, the Down Port unit receives zero length data from the USB device through IN (indicating that device configuration setting is complete), and transmits an IN-ACK to the WUSB host. Until this request is complete, the EP configuration of the Up Port unit 10 is set on the basis of the configuration information obtained in the Get Descriptor request processing described above.

From the EP information of the held configuration information described above, EP setting can be performed on the PIPE 1 control unit 54, PIPE 2 control unit 55 and PIPE 3 control unit 56 of the endpoint control unit 50. By setting the device EP configuration (and address) identically in the Up Port unit 10 and the connected device, C-WUSB communication becomes possible. Hence, by making endpoint setting variable and performing setting during enumeration, the EP configuration of the endpoint control unit 50 can be made to correspond one-to-one to the EP configuration of the connected device. Note that in this case, C-WUSB transformation can be ensured by making the number of endpoints in the endpoint control unit 50 equal to or greater than the number of endpoints in the connected device, but even when the proportion of EP numbers is opposite, for example when only the printer function of a multifunction printer is made wireless, C-WUSB transformation can be achieved by limiting a part of the functions of the connected device.

Note that in this embodiment, the endpoint configuration is made variable and set during enumeration, but for example, a plurality of EPs having defined directions and transfer methods may be prepared in advance, and the EP configuration, such as the EP number, may be determined to correspond one-to-one to the EP configuration of the connected device connected to the Down Port. In this case, a conversion table or the like is prepared, and the EP configuration is determined such that the EP configuration obtained during enumeration and the EP configuration of the connected device correspond to each other one-to-one. Further, a connected device may be specified in advance, and the EP configuration of the specified connected device may be set in advance. In this case, the EP configurations correspond to each other one-to-one in advance, and therefore the need to perform attribute setting and prepare a correspondence table is eliminated. Hence, this is an extremely simple method suitable for use in an incorporated type, for example.

Next, a connected device operation is executed from the WUSB standard request control unit 51 to the host controller 31 via the PIPE 1 control unit 54 and so on. In this case, C-WUSB and USB 2.0 communication are implemented through the WUSB-USB convertor 20.

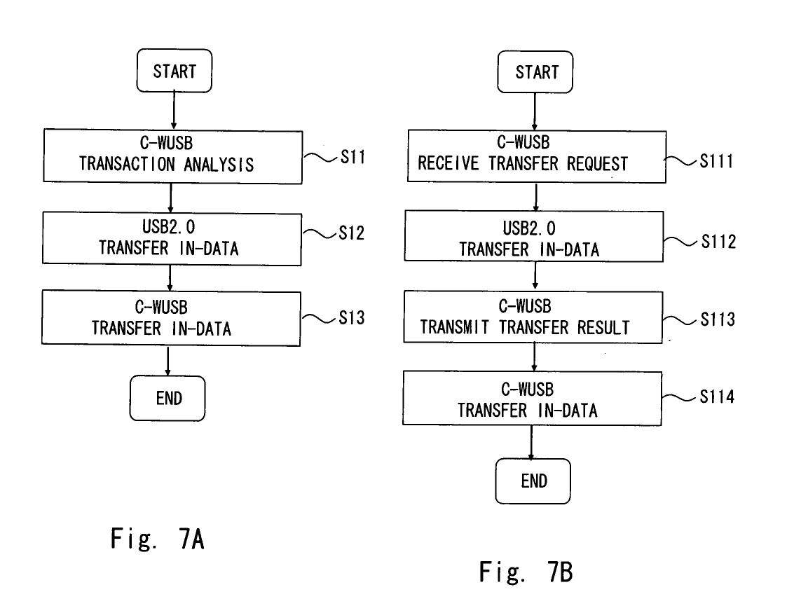

Next, the device operation of a step S4 will be described. FIGS. 7A and 7B are flowcharts showing IN data transfer processing during a device operation of the communication adapter according to the first embodiment of the present invention and a DWA, respectively.

In a C-WUSB or a pre-existing USB, transfer-related scheduling is all performed by the host as standard. The device is incapable of transmitting data even when it has data to be transmitted. In other words, transmission only becomes possible from the host when an IN token (transmission request) is present. In the case of OUT, OUT data are transmitted from the host in response to an OUT token (reception request).

In this embodiment, the Up Port is connected to the C-WUSB host, and the Down Port is connected to a Wired USB. An operation corresponding to an instruction from the C-WUSB host connected to the Up Port must also be performed as a Wired USB operation of the Down Port. The reason for this is that the IN→OUT order may simply become confused such that communication cannot be established, for example. In the case of OUT, tokens and data transmitted from the host need only be passed to the Down Port side, but in the case in IN, data must be obtained by issuing an IN token to the Wired USB side of the Down Port in order to transmit data to the C-WUSB host. The following two methods may be used as means for realizing this.

In a first method, an IN token is received from the C-WUSB host, whereupon data are obtained by issuing an IN token as the host of the Wired USB. In this case, at least one NAK response is invariably issued to the C-WUSB host. The merits of this method are that control is simple and reliable. Furthermore, the method can be used in all device classes. However, due to the invariable NAK response, the throughput decreases slightly.

In a second method, data are obtained in advance by issuing an IN token as the host of the Wired USB before the IN token is received from the C-WUSB host. In this method, the data are read in advance, and therefore the throughput is favorable. However, the IN, OUT order and so on must be learned in advance, and command analysis and so on are required (step S11). Therefore, the device class is limited. In the mass storage class, for example, by analyzing the content of initial OUT data, it is possible to determine whether or not IN data processing is to follow. As will be described in detail below, by obtaining device class information, optimal data transfer processing can be selected and executed. In other words, this embodiment can respond to a plurality of device classes while maintaining a high level of performance and without initially specifying the connected device.

Further, the two methods described above may be combined to create a method in which an IN token is received from the C-WUSB host first, whereupon IN transfer processing is repeated on the Wired USB side until a short packet is received from the connected device.

Next, the Down Port unit 30 issues an IN token to the connected USB device, and receives data from the connected device (step S12).

Finally, the C-WUSB host issues an IN-DATA transfer request to the subject endpoint of the Up Port unit 10. In response to this IN request, the IN-DATA received by the Down Port unit 30 in the step S12 are transmitted to the W-USB host. The transfer system is identical to that of the step S12.

In a DWA, on the other hand, as shown in FIG. 7B, first a transfer request is received from the C-WUSB host by a reception endpoint of the DWA (step S111). The transfer system at this time is Bulk OUT. Next, IN transfer is executed on the basis of an RPipe (information such as an address, an EP number, and a transfer system) specified in the transfer request. As a result, data from the connected device (USB 2.0) are received (step S112). Next, the C-WUSB host issues an IN transfer request to a transmission endpoint. In response to this IN request, the DWA transmits a transfer result (step S113). The transfer system at this time is Bulk IN. Finally, the C-WUSB host issues an IN-DATA transfer request to the transmission endpoint. In response to this IN request, the IN-DATA received in the step S112 are transmitted from the DWA to the C-WUSB host. The transfer system here is Bulk IN transfer. Since the DWA receives a transfer request and transmits a transfer result, the transfer processing takes time.

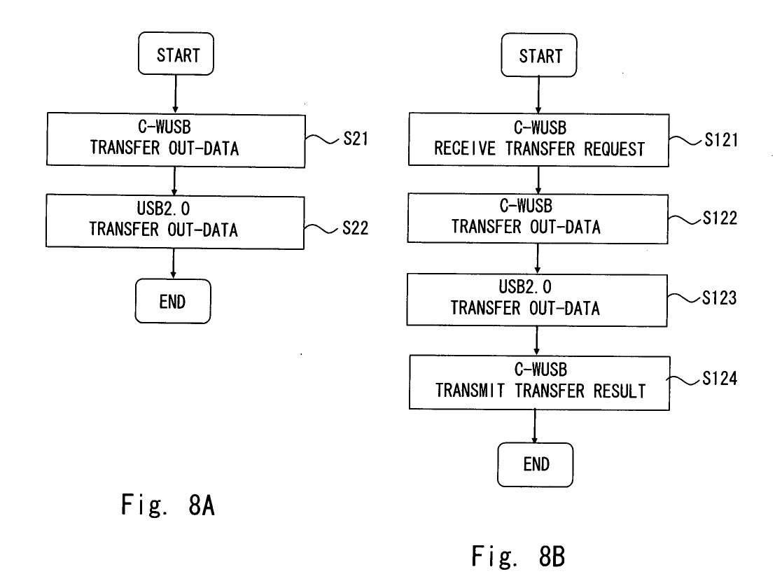

Next, OUT data transfer processing will be described. FIG. 8A is a flowchart showing an OUT data transfer method of the communication adapter according to this embodiment. FIG. 8B shows an OUT transfer method of a DWA for comparison. When OUT data are transferred in the communication adapter 2 according to this embodiment, OUT-DATA from the C-WUSB host are received by the subject endpoint of the Up Port unit 10 (step S21). The Down Port unit 30 then issues an OUT token to the same endpoint as the Up Port unit 10 which is the subject of the connected device. Then, the data received by the Up Port unit 10 in the step S21 are transmitted to the connected device (step S22). The transfer system is identical to that of the step S21.

In a DWA, on the other hand, a transfer request is received by the reception endpoint of the Up Port unit (step S121). The transfer system here is Bulk OUT transfer. Next, OUT-DATA from the C-WUSB host are received by the reception endpoint of the DWA (step S122). Next, OUT transfer is executed on the basis of an RPipe (information such as an address, an EP number, and a transfer system) specified in the transfer request. In other words, the data received in the step S122 are transmitted to the connected device (step S123). Finally, the C-WUSB host issues an IN transfer request to the transmission endpoint. In response to this IN request, a transfer result is transmitted. The transfer system here is Bulk IN transfer. Since the DWA must also transmit a transfer request and a transfer result during OUT transfer, the throughput decreases.

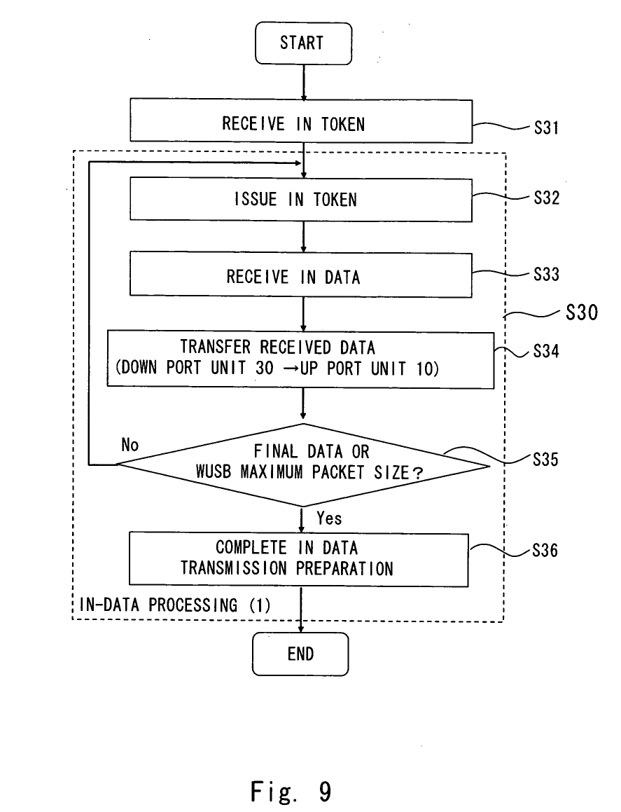

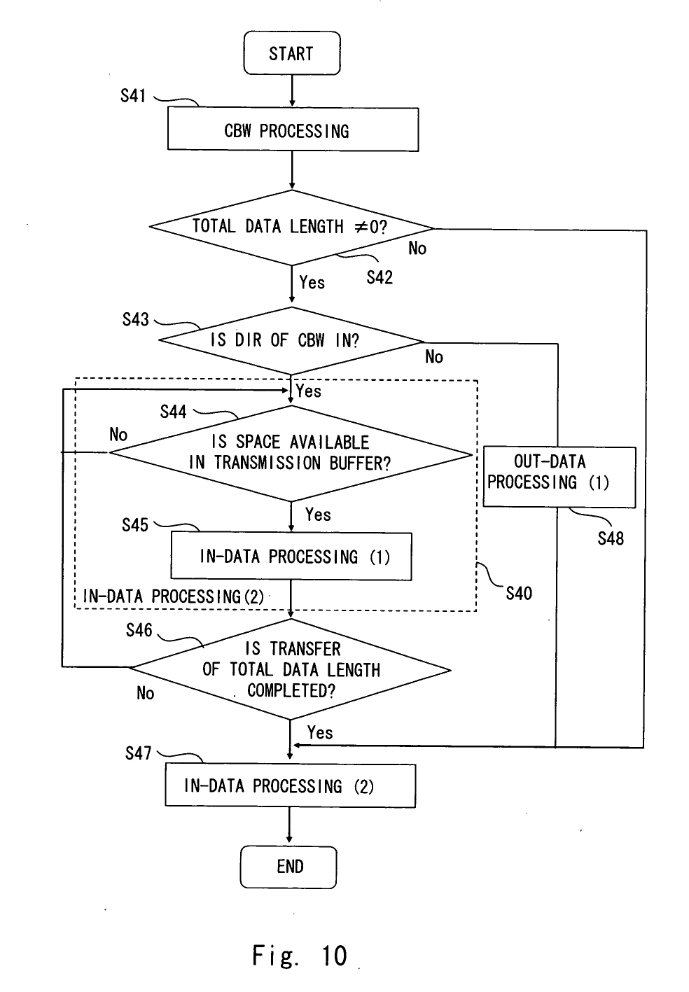

Next, IN transfer processing will be described in detail. FIG. 9 is a flowchart showing in detail IN data transfer processing in the communication adapter according to the first embodiment of the present invention. Likewise, FIG. 10 is a flowchart showing in detail IN data transfer processing in the communication adapter according to the first embodiment of the present invention, illustrating IN data transfer processing in the mass storage class.

As shown in FIG. 9, first, when the Up Port unit 10 of the communication adapter receives an IN token from the C-WUSB host (step S31), the Down Port unit 30 issues an IN token to the connected device (step S32). In response, IN data are transmitted from the connected device and received by the Down Port unit 30 (step S33). Next, the received data are transferred from the Down Port unit 30 to the Up Port unit 10 (step S34). The Up Port unit 10 then determines whether or not the transferred data are final data or have a maximum packet size, and when the data are not final data and are not of the maximum packet size, the processing is repeated from the step S32. When the data are final data or have the maximum packet size, preparation for transmitting IN data from the Up Port 10 to the C-WUSB host is deemed complete (step S35). This IN transfer method can be employed regardless of the device class. Processing extending from the point at which the communication adapter issues the IN token to the point at which IN data transmission preparation ends will be referred to as IN-DATA processing (1).

Next, an IN transfer processing method in the case of the mass storage class will be described. As shown in FIG. 10, in the mass storage class, the Up Port unit 10 performs command analysis as CBW (Command Block Wrapper) processing (step S41), determines whether or not the total data length is 0 (step S42), and when the total data length is not 0, determines whether or not the transfer direction (DIR) of the data processing is IN (step S43). When the total data length is not 0 and the transfer direction is IN, the Up Port unit 10 determines whether or not space is available in a transmission buffer (step S44). When space is available in the transmission buffer, the Down Port unit 30 and Up Port unit 10 implement the IN-DATA processing (1) described above (step S45). Once the Up Port unit 10 has confirmed that transfer of the total data length is complete (step S46: Yes), IN-DATA processing (2), which is constituted by the step S44 and the step S45, is implemented again (step S47). The IN-DATA processing (2) is CSW (Command Status Wrapper) processing.

On the other hand, when the total data length is determined to be 0 in the CBW analysis of the Up Port 10 (step S42: No), the IN-DATA processing (2) of the step S47 is implemented, after which processing is terminated. Further, when the Up Port 10 determines that the total data length is not 0 and the transfer direction is not IN (step S43: No), the Up Port 10 and Down Port unit 30 implement OUT-DATA processing (1), to be described below (step S48), and then implement the IN-DATA processing (2) of the step S47, after which the processing is terminated.

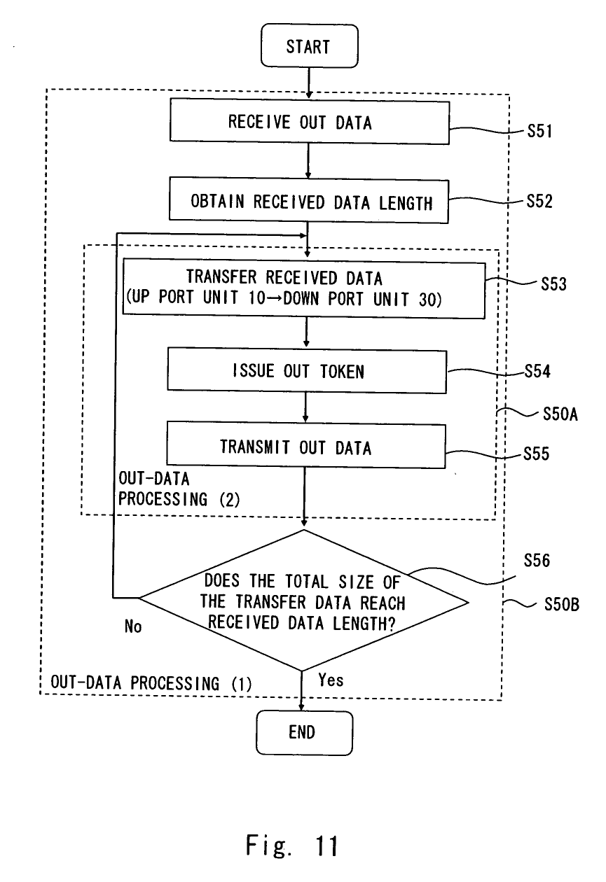

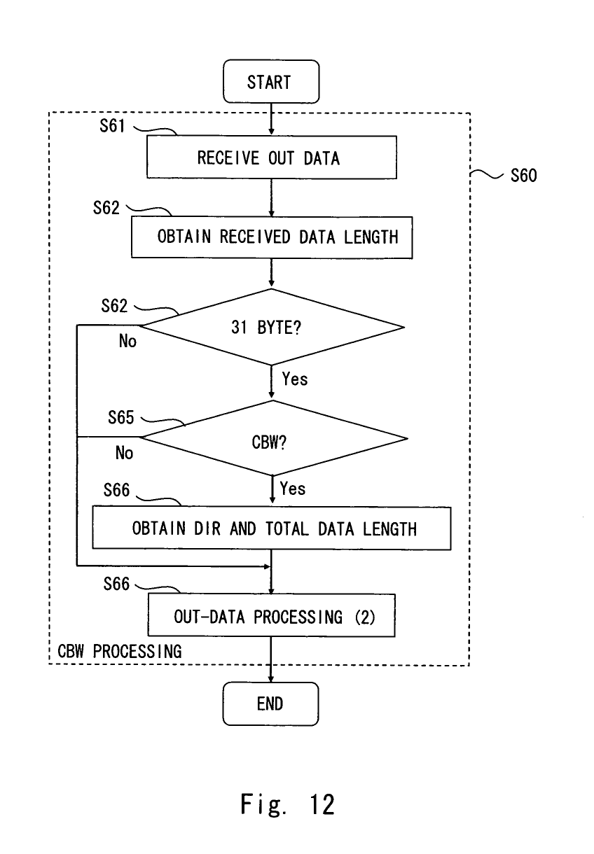

Next, OUT transfer processing will be described in detail. FIG. 11 is a flowchart showing in detail OUT data transfer processing in the communication adapter according to the first embodiment of the present invention. Likewise, FIG. 12 is a flowchart showing in detail OUT data transfer processing in the communication adapter according to the first embodiment of the present invention, illustrating OUT data transfer processing in the mass storage class.

As shown in FIG. 11, first, when the Up Port unit 10 receives OUT data (step S51), the Up Port unit 10 obtains the received data length (step S52). Next, the Up Port unit 10 receives the received data from the C-WUSB host and transfers the received data to the Down Port unit 30 (step S53). Next, the Down Port unit 30 issues an OUT token to the connected device (step S54), and transmits the OUT data to the connected device (step S55). When the Up Port unit 10 confirms that transfer of the received data length is complete, the processing is terminated (step S56). When transfer of the received data length is not complete, the processing is repeated from the step S53. Here, the series of processing from the step S51 to the step S56 is set as OUT-DATA processing (1), and the series of processing from the step S53 to the step S55 is set as OUT-DATA processing (2).

Next, an OUT transfer processing method in the case of the mass storage class will be described. As shown in FIG. 12, in the mass storage class, when the Up Port unit 10 receives the OUT data (step S61), the Up Port unit 10 obtains the received data length similarly to the processing described above (step S62). The Up Port unit 10 then checks whether or not the received data length is 31 bytes (step S63), and then checks whether or not the received data are a CBW (step S64). When the received data are a CBW, the Up Port unit 10 obtains the transfer direction (DIR) and the total data length (step S65). Next, the OUT-DATA processing (2) described above is implemented. Here, the series of processing from the step S61 to a step S66 is set as CBW processing. By means of this CBW processing, it is possible to determine whether the subsequent transfer processing is IN or OUT, and when the subsequent transfer processing is IN, the transfer speed is improved by pre-reading the data.

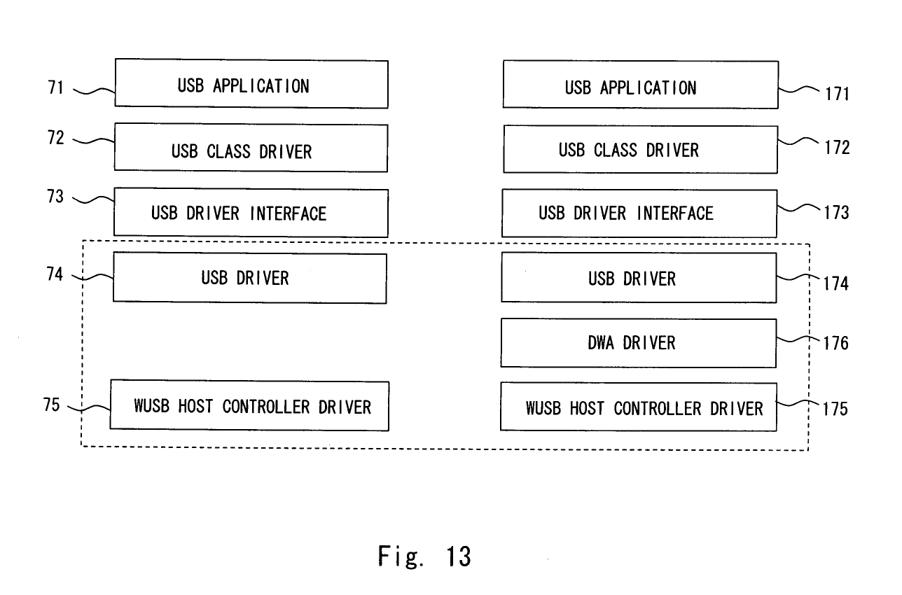

FIG. 13 is a view illustrating the effects of this embodiment by showing a driver configuration when the communication adapter is used. As shown in FIG. 13, both the communication adapter according to this embodiment and a DWA require a USB application 71, 171, a USB class driver 72, 172, and a USB driver interface 73, 173. Pre-existing USB 2.0 resources may be diverted for use without modification as the USB application, USB class driver, and USB driver interface.

Here, the DWA also requires a USB driver 174, a DWA driver 176, and a WUSB host controller driver 175, whereas the communication adapter according to this embodiment requires only a USB driver 74 and a C-WUSB host controller driver 75, and does not require a DWA driver 176.

Hence, even though a C-WUSB host controller driver is required, a set manufacturer can focus more closely on device development, and a reduction in cost can be achieved.

A DWA places no limits on the connected device and enables connection of a USB device including a hub to a plurality of down ports, and therefore a DWA possesses universality. However, this universality leads to an increase in protocol overheads. A DWA must always perform transfer request reception and transfer result transmission as transfer units, and therefore, in comparison with an ND, two surplus transactions are performed. In this embodiment, on the other hand, a C-WUSB ND protocol is followed, and therefore protocol-dependent overheads are small in comparison with a DWA. Further, since the IN of the Wired USB can be pre-read during CBW analysis, as in the mass storage class, for example, optimal processing specific to the connected device can be implemented. Hence, as described above, double or triple throughput can be achieved, and a high speed can be secured.

Further, the remote pipe controller and so on required by the DWA can be eliminated. More specifically, in this embodiment, it is sufficient to control endpoints that correspond one-to-one to the endpoints of the connected device. Furthermore, [this embodiment] is limited to a single port, and the EP number can be limited. Also, a hub connection can be eliminated, HS/FS transportation cannot be limited, and so on, and therefore the functions as a host can be simplified greatly. Moreover, the number of down ports is limited to a single port, and therefore the analog unit (physical layer) can be reduced in size correspondingly. Hence, a large reduction in circuit scale can be achieved in comparison with a DWA.

### Second Embodiment

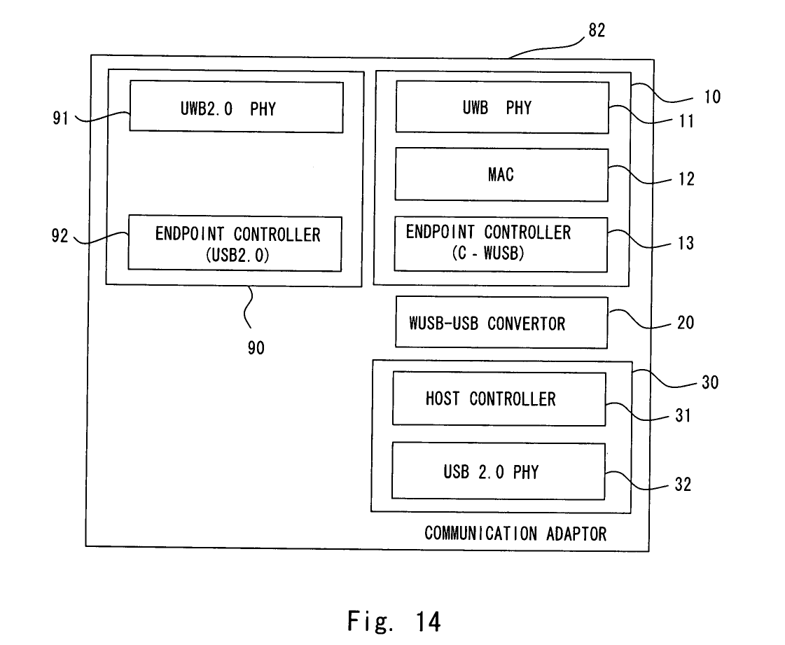

FIG. 14 is a block diagram showing a communication adapter according to a second embodiment of the present invention. A communication adapter 82 according to this embodiment corresponds to the communication adapter 2 according to the first embodiment with the addition of a USB 2.0 device unit 90. The USB 2.0 device unit 90 comprises a USB 2.0 physical layer 91 connected to the Up Port side, and an endpoint controller 92 for controlling USB 2.0 endpoints connected to the Up Port side.

By combining the USB 2.0 device unit 90 and the Down Port unit 30, an operation as a wired USB device can be performed as is while ensuring compatibility with cable association, which is a C-WUSB communication security system. By means of the USB 2.0 device unit 90, a security-related function can be packaged in a C-WUSB. Moreover, an operation can also be performed as a pre-existing USB device, and thus the end user can select between a wired operation and a wireless operation. As for a conversion operation from a USB device to a USB host, the connected USB device always appears to be a normal USB cable, and therefore control during a cable operation required in the C-WUSB can be closed into the circuitry according to this embodiment. Hence, a C-WUSB can be formed simply through connection to a pre-existing USB.

Note that in this embodiment, the USB 2.0 device unit 90 has been added, but the communication adapter may be constituted by the USB 2.0 device unit 90 and the Down Port unit 30 alone. In other words, a Wired USB may be connected to the Up Port.

Note that the present invention is not limited to the embodiments described above, and may of course be subjected to various modifications within a scope that does not depart from the spirit of the present invention. For example, in the embodiments described above, a hardware constitution was described, but the present invention is not limited thereto, and the desired processing may be realized by having a CPU (Central Processing Unit) execute a computer program. In this case, the computer program may be provided in recorded form on a recording medium, or may be transmitted via the Internet or another transmission medium.

Further, the communication adapter according to the first or second embodiment may be installed in a DWA such that the DWA and the communication adapter according to the embodiments are switched using a switch. In this case, the user switches appropriately between a mode in which the connected device is limited but use as a high-speed adapter (the first and second embodiments) is possible and a mode in which the connected device is not limited but only use as a low/medium speed adapter (DWA) is possible, according to necessity. Further, only one of a plurality of Down Ports may be allocated to the embodiments.

It is apparent that the present invention is not limited to the above embodiments, but may be modified and changed without departing from the scope and spirit of the invention.

What is claimed is:

1. A communication adapter comprising:
a host controller to interact with a connected device that is USB connected to the communication adapter;
a wireless communication unit which communicates with an external wireless communication apparatus, and which has an endpoint configuration that corresponds one-to-one to an endpoint configuration of the connected device; and
a data convertor which converts data from the wireless communication apparatus into data to be transmitted to the connected device, and converts data from the connected device into data to be transmitted to the wireless communication apparatus,
wherein data transfer is performed between the wireless communication apparatus and the connected device.

2. The communication adapter according to claim 1, wherein the wireless communication unit has an endpoint number equal to or greater than the endpoint number of the connected device, and sets an endpoint configuration on the basis of configuration information relating to the connected device, which is obtained during enumeration.

3. The communication adapter according to claim 1, wherein the wireless communication unit has a predetermined endpoint configuration in which a transfer type and a transfer direction are fixed, and sets the endpoint configuration on the basis of configuration information relating to the connected device, obtained during enumeration, so as to correspond to the endpoint configuration of the connected device.

4. The communication adapter according to claim 1, wherein
the connected device is a predetermined, specific USB device, and
the wireless communication unit has an identical endpoint configuration to the specific USB device.

5. The communication adapter according to claim 1, wherein
the wireless communication unit comprises an endpoint controller to control an endpoint,
the endpoint controller comprises a request processing unit to process a request to be transmitted to the connected device, and
the request processing unit inputs a request from the external wireless communication apparatus into the connected device via the data convertor.

6. The communication adapter according to claim 2, wherein
the wireless communication unit comprises an endpoint controller to control an endpoint,
the endpoint controller comprises a request processing unit to process a request to be transmitted to the connected device, and
the request processing unit inputs a request from the external wireless communication apparatus into the connected device via the data convertor.

7. The communication adapter according to claim 1, wherein the data convertor is a wireless USB-USB convertor that converts wireless USB data from the wireless communication apparatus into USB data to be transmitted to the connected device, and converts USB data from the connected device into wireless USB data to be transmitted to the wireless communication apparatus.

8. The communication adapter according to claim 2, wherein the data convertor is a wireless USB-USB convertor that converts wireless USB data from the wireless communication apparatus into USB data to be transmitted to the connected device, and converts USB data from the connected device into wireless USB data to be transmitted to the wireless communication apparatus.

9. The communication adapter according to claim 1, wherein
the data convertor comprises:
a wireless USB controller to control wireless USB communication;
a USB controller to control USB communication;
a protocol convertor to mutually convert a wireless USB protocol and a USB protocol; and
an endpoint information unit storing endpoint information.

10. The communication adapter according to claim 2, wherein
the data convertor comprises:
a wireless USB controller to control wireless USB communication;
a USB controller to control USB communication;
a protocol convertor to mutually convert a wireless USB protocol and a USB protocol; and
an endpoint information unit storing endpoint information.

11. The communication adapter according to claim 9, wherein the data convertor further comprises a class information unit to extract class information from the configuration information relating to the connected device.

12. The communication adapter according to claim 9, wherein the data convertor comprises a class control unit to decode a command from the wireless communication apparatus.

13. The communication adapter according to claim 11, wherein the data convertor comprises a class control unit to decode a command from the wireless communication apparatus.

14. The communication adapter according to claim 1, further comprising a USB communication unit to communicate with an external USB host.

15. The communication adapter according to claim 2, further comprising a USB communication unit to communicate with an external USB host.

16. The communication adapter according to claim 1, wherein the wireless communication unit extracts device class information from the configuration information relating to the connected device, obtained during enumeration, and executes transfer processing on the basis of a corresponding device class.

17. A data transfer method of a communication adapter for performing data transfer between a connected device that is USB connected to the communication adapter and an external wireless communication apparatus,
the method comprising the steps of:
receiving a transmission request from the external wireless communication apparatus in a wireless communication unit having an endpoint configuration that corresponds one-to-one to an endpoint configuration of the connected device;
issuing an IN token to the connected device and receiving data from the connected device; and
transferring the data to the wireless communication apparatus from the connected device.

18. A data transfer method of a communication adapter for performing data transfer between a USB device connected to the communication adapter and an external wireless communication apparatus,
the method comprising the steps of:
issuing an IN token to a connected device and obtaining data regardless of whether or not an IN token is received from the external wireless communication apparatus by a wireless communication unit having an endpoint configuration that corresponds one-to-one to an endpoint configuration of the connected device; and
transferring the data obtained from the connected device after the wireless communication unit has received an IN token from the wireless apparatus.

19. The data transfer method of a communication adapter according to claim 17, wherein after connection processing with the external wireless communication apparatus has been implemented,
authentication is performed by implementing security-related request processing with the wireless communication apparatus,
configuration information relating to the connected device is obtained by performing enumeration on the connected device between the wireless communication apparatus and the connected device via the communication adapter,
a device class is extracted from the configuration information, and
a device operation is executed on the basis of the device class.

20. The data transfer method of a communication adapter according to claim 18, wherein after connection processing with the external wireless communication apparatus has been implemented,
authentication is performed by implementing security-related request processing with the wireless communication apparatus,
configuration information relating to the connected device is obtained by performing enumeration on the connected device between the wireless communication apparatus and the connected device via the communication adapter,
a device class is extracted from the configuration information, and
a device operation is executed on the basis of the device class.
